(19) United States
(12) Patent Application Publication
(10) Pub. No.: US 2011/0052154 A1
(43) Pub. Date: Mar. 3, 2011

(54) TRANSITION OBJECT FREE EDITING

(76) Inventor: Markus Weber, Woerth (DE)

(21) Appl. No.: 12/553,135

(22) Filed: Sep. 3, 2009

(51) Int. Cl. H04N 5/93; H04N 5/783; G11B 27/00

(52) U.S. Cl. 386/280; 386/E05.001; 386/282; 386/350

(57) ABSTRACT

Computer-based editing methods and systems for defining and generating transitions between video clips in a video presentation. Transition regions are defined at one or both ends of a video clip such that the transition region remains defined on the first video clip until the transition region is edited or deleted by a user. Making the transition region a property of the clip upon which the transition region is defined, and retaining that property while the clip is manipulated within a timeline of a video editing system reduces ambiguity as to how transitions are to be treated in the editing process. It also helps reduce loss of original video material associated with transition regions during the editing process.

### BACKGROUND

In order to create a video program, editors start with individual clips of video and/or audio and place them in a linear sequence to create a program that is composed of a series of video clips. It is common practice to use some kind of transition, also known as a “blend effect” between two successive clips in a video program to help the viewer adjust to the new clip or to alert the viewer that a cut has been made. The traditional method of creating transitions owes its origin to the era when video was stored and played back on video tape recorders (VTRs). The video editor would position the end of the first clip on the first VTR, and the beginning of the second clip on a second VTR, and then roll (play) the two VTRs simultaneously into a purpose-built device called an effects engine that would combine the two incoming VTR signals in a prescribed way, and then output the results for recording on a third VTR. As editing moved from tape-based systems to all-digital systems, the concept of an effects engine was implemented using the notion of a transition object with two inputs and one output. The inputs were the end of the first clip and the beginning of the second clip, and the output was the calculated blend (transition) of the first clip and the second clip.

In present-day video editors, the historical implementation of a transition is represented as a stand-alone transition object, an entity that is handled independently of the two source clips it operates upon. In this paradigm, the transition object contains the video that plays during the transition period, this video being based on the two inputs from the adjoining video clips, the video being generated using a transition effect rule or algorithm for combining the two inputs, and optionally for adding other graphic elements.

Novice users of video editing applications are generally not aware of the history of video editing, and, though they want to achieve a transition between clips, the notion of using a transition object for this purpose is not intuitive for them. Furthermore, when one of the clips on either side of a transition is deleted, an ambiguity can arise as to how to handle the transition—should the cut be made at the beginning of the transition, eliminating the transition object entirely, or in the middle of the transition? If the deleted clip is sandwiched between a first and a third clip, should one of the transition objects on either side of the deleted clip be retained, and if so, which one? The present application addresses these problems.

### SUMMARY

The invention features methods, systems, and computer program products for defining, implementing, and editing transitions between video clips that make up a video presentation. In one aspect, a computer-based editing system for editing a video presentation includes placing a first video clip into a timeline, the timeline representing a time sequence of elements within the video presentation; defining a transition region of the first video clip, the transition region of the first video clip having a start and an end, the transition region being one of an incoming transition region having a start corresponding to a first frame of the first video clip and an outgoing transition region having an end corresponding to a last frame of the first transition region, the transition region having a duration and specifying the region of the first video clip over which a transition effect is to be applied, wherein the transition region remains defined on the first video clip until the transition region is edited or deleted by a user of the computer-based editing system; and generating a transition effect based at least in part on video content of the transition region of the first video clip.

Some embodiments include one or more of the following features. The transition region remains defined on the first video clip when: the first video clip is moved from a first location in the timeline to a second location in the timeline; video content in the timeline adjacent to the transition region in the second location is different from video content in the timeline adjacent to the transition region in the first location; and video content in the timeline adjacent to the start of an incoming transition or the end of an outgoing transition region of the first clip is changed. Changing the video content in the timeline adjacent to the transition region includes at least one of deleting a second video clip adjacent to the first video clip and inserting a second video clip adjacent to the first video clip. If the transition region is an incoming transition region, the transition effect is a fade-in from transparent black at the start of the transition region to full opacity of the first video clip at the end of the transition region, and if the transition region is an outgoing transition region, the transition effect is a fade-out from full opacity of the first video clip at the start of the transition region to black at the end of the transition region.

In other embodiments, the methods, systems, and computer program products further include: placing a second video clip in the timeline, an adjacent end of the second video clip abutting the transition region defined on the first video clip; and generating a transition effect between the first video clip and the second video clip by extending the second video clip to create an extension of the second video clip having a duration equal to the duration of the transition region of the first video clip, and combining video from the transition region of the first video clip with the extension of the second video clip. Further embodiments include one or more of the following features: the second video clip is a portion of a source video clip, the source video clip having a duration longer than a duration of the second video clip in the timeline, the extension of the second video clip including additional video from the source video clip extending beyond the adjacent end of the second video clip; and the extension of the second video clip includes multiple repetitions of an end frame of the adjacent end of the second video clip.

In another aspect, a computer program product includes a computer readable medium and computer program instructions stored on the computer readable medium that, when executed by a computer, define an editing system for editing a video program and instruct the computer to perform a method for enabling a user to edit a video presentation. The method includes placing a first video clip into a timeline, the timeline representing a time sequence of elements within the video presentation; defining a transition region of the first video clip, the transition region of the first video clip having a start and an end, the transition region being one of an incoming transition region having a start corresponding to a first frame of the first video clip and an outgoing transition region having an end corresponding to a last frame of the first transition region, the transition region having a duration and specifying the region of the first video clip over which a transition effect is to be applied, wherein the transition region remains defined on the first video clip until the transition region is edited or deleted by the user of the compute-based editing system; and generating a transition effect based at least in part on video content of the transition region of the first video clip.

In yet another aspect, a computer-implemented video editing system includes a processor that processes a computer program so as to provide a system for editing a video program. The processor is further configured to: provide a graphical user interface to enable a user to place a first video clip into a timeline, the timeline representing a time sequence of elements within the video presentation, and to enable the user to define a transition region of the first video clip, the transition region of the first video clip having a start and an end, the transition region being one of an incoming transition region having a start corresponding to a first frame of the first video clip and an outgoing transition region having an end corresponding to a last frame of the first transition region, the transition region having a duration and specifying the region of the first video clip over which a transition effect is to be applied, wherein the transition region remains defined on the first video clip until the transition region is edited or deleted by a user of the computer-based video editing system; and generate a transition effect based at least in part on video content of the transition region of the first video clip.

### BRIEF DESCRIPTION OF THE DRAWINGS

FIG. 1 is a diagram showing a representation of a video clip in a timeline.

FIG. 2 is a diagram showing how a transition is generated between two clips when one of the clips has a defined transition.

FIG. 3 is a diagram showing how a transition is generated between two clips, each having a defined transition.

FIG. 4 is a diagram showing generation of overlap transitions.

FIG. 5 is a diagram showing the behavior of transitions with three clips in a timeline.

FIG. 6. is a high level diagram of a computer system for implementing a video editing system.

### DETAILED DESCRIPTION

During the process of creating and editing a video presentation using a computer-based non-linear video editing system, a user retrieves video clips that are to form a part of the presentation, and places them in a desired sequence in the video presentation. The user retrieves the clips from a bin that represents the available clips, which can be stored locally or remotely. A graphical user interface facilitates the user's ability to view which clips are available, to search for additional clips that may be available to him, and to select one or more clips for inclusion within the video presentation. The video editing program represents the video presentation within a timeline that shows the location and duration of the inserted clips. Once inserted into the timeline, the user can move a clip forward and backward in time, which is usually represented by moving the clip to the right (forward in time) or to the left (backward in time) within the timeline. Non linear editors also feature the ability to change the order of clips within the timeline, to delete clips, or to insert additional clips anywhere within the timeline.

It is a common requirement for two clips that are placed adjacent to each other in the timeline to have some kind of transition between them. Such a transition avoids an abrupt cut as the presentation plays through the end of the first clip into the beginning of the second clip. Transitions provide the video editor (user) with the ability to achieve a number of effects, such as smoothing the transition or giving an indication of what is to be expected in the upcoming clip.

In traditional video editing systems, users insert and edit transitions between adjacent clips using transition objects. In such systems, the transition object, once inserted into the timeline, becomes independent of the adjacent clips, and the user can manipulate or remove these objects without apparently affecting the clips adjacent to them in the timeline. However, as indicated in the background section above, this approach causes difficulties for many users, especially if they are new to non-linear video editing. For many such users, the notion of a transition object is not intuitive, and they do not at first understand that such an object is needed, or where to find them within the video editing system. Furthermore, the use of transition objects gives rise to ambiguities when clips are deleted, moved, and inserted because there are a number of different ways to treat transition objects in such circumstance, none of which are intuitively clear for many users.

In the video editing system described here, the notion of a transition object is eliminated. Instead, transitions become a property of a clip; once the user defines a transition on a clip, the transition remains associated with that clip as long as the clip remains within the timeline. In particular, the transitions remain associated with the clip when the clip is moved to another location within the timeline, or when the content of the timeline adjacent to the clip changes. Thus, a transition that the user defines at the beginning of Clip A remains unchanged when Clip A is cut and pasted or dragged into another location within the timeline. In addition, the transition is not deleted or altered when a clip immediately prior to Clip A is deleted or replaced by another clip, or if a blank region is placed before clip A. In other words, once the user has defined a transition region on a clip, it remains defined unless and until the user acts to delete or edit the transition, for example by changing the duration of the transition, including changing it to zero (equivalent to deleting the transition), or by cutting the portion of the clip on which the transition is defined.

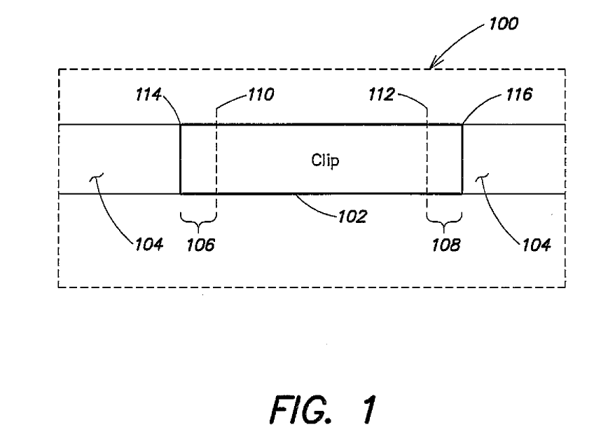

Referring to FIG. 1, which is a diagrammatic representation of a portion 100 of a video editor display, clip 102 within timeline 104 can have two kinds of transition, an incoming transition and an outgoing transition. An incoming transition spans incoming transition region 106 of clip 102, the region starting at the beginning of the clip. Conversely, an outgoing transition spans outgoing transition region 108 of clip 102, the region ending at the end of clip 102. Marker 110 indicates the end of incoming transition region 106 and marker 112 indicates the beginning of outgoing transition region 108.

The transition effect to be applied to a transition region is any one of the effects that are made available in the transition effect library of the video editing system. Such effects include fade, dissolve, wipe, fly-in, page-turn, and others. In the described embodiment, the default transition effect is fade-in (dissolve) for an incoming transition effect and fade-out for an outgoing transition effect. Thus if the default transition effects are applied to clip 102 as shown in FIG. 1, i.e., without a preceding or succeeding clip, the clip would start with a fade-in from black at the start 114 of the clip, with the opacity of the clip increasing to 100% when marker 110 is reached, and end with a fade-out starting when marker 112 is reached, becoming black at the end 116 of the clip.

A transition effect is generally defined by specifying how two video sources are to be combined within the applicable transition region. In the default case for a single clip described in the previous paragraph, the two video sources are transparent black and clip 102. We now describe how transition effects are implemented without the use of transition objects when two clips lie adjacent to each other in the timeline.

The general rule is to use the clip immediately adjoining a given clip in its natural end state as the partner in an incoming or outgoing transition. The following explains how this general rule is applied in some common scenarios.

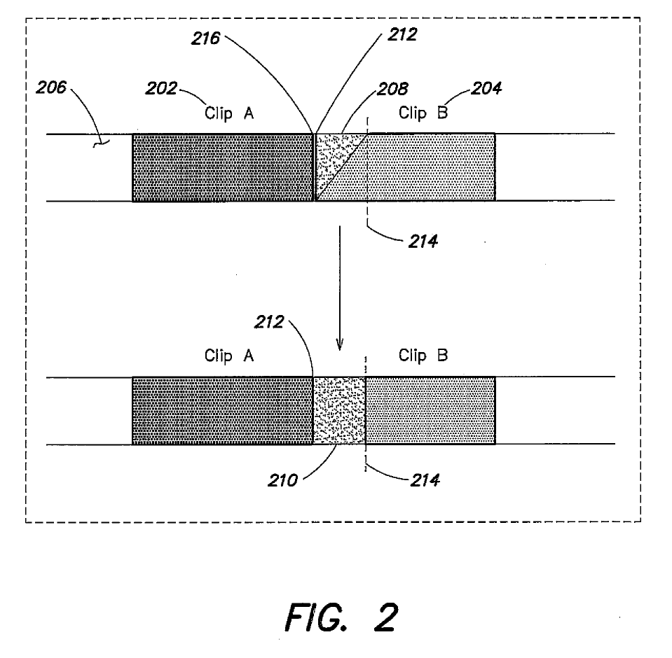

In a first scenario, illustrated in FIG. 2, the user places Clip A 202 adjacent to Clip B 204 in timeline 206 and defines incoming transition region 208 on Clip B, but no transitions on Clip A. Note, the order of the operations can be reversed, in which case the user first defines transition region 208 on clip B, and then places Clip A immediately preceding Clip B in the timeline. In either case, the system implements transition 210 between Clip A and Clip B by extending Clip A to fill the time span of incoming transition region 208. Significantly, transition 210 is created without altering the duration of the sum of the two clips. Thus Clip B is not moved to the left to overlap Clip A, and so there is no ripple to the left when the transition is created. Consequently, if timeline 206 represents one of a plurality of tracks in a video presentation, the creation of the transition does not cause the loss of synchronization between Clip B (and any material there might be to the right of it) with other tracks.

If the incoming transition effect is set to fade-in, the system implements fade transition 210 from 100% opacity of the end frame of Clip A at mark-in point 212 of Clip B, to 100% opacity of Clip B at incoming transition region endpoint 214. If Clip A is subsequently deleted, transition region 208 remains defined on Clip B, and if the user subsequently replaces Clip A with Clip C (not shown), the transition effect is defined as described above by extending Clip C (instead of Clip A) into transition region 208. The system creates the necessary extension of Clip A by using additional source material from Clip A that extends beyond mark-out point 216 of Clip A (i.e., to the right in the timeline of point 216), or if there is insufficient material in Clip A beyond the mark-out point (also known as the “missing meat” problem), by replicating the end frame of Clip A (or of Clip C, if it has replaced Clip A) as many times as necessary to fill the time span of the Clip B incoming transition.

The system implements an analogous transition in the mirror case in which the user defines an outgoing transition on the first of two adjacent clips, and does not define an incoming transition on the second clip. In this scenario, the system extends the second clip by an amount corresponding to the time span of the outgoing transition on of the first clip. As with the previous case, the material for the extension is drawn from addition source material from the first clip prior to its mark-in point, or, if there is insufficient material available, by replicating the first frame of the second clip as many times as needed to fill the transition time span.

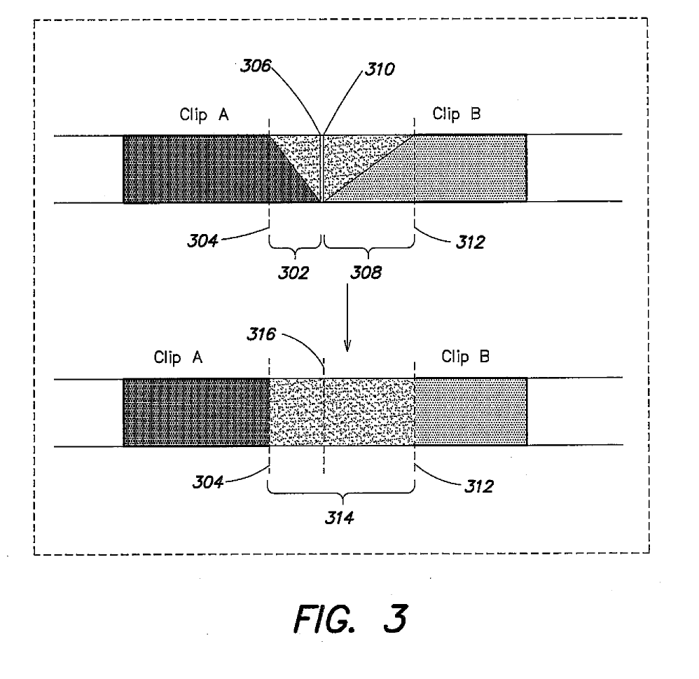

In a second scenario, the user defines both an outgoing transition and an incoming transition on adjacent ends of two clips in the timeline, as illustrated in FIG. 3. Outgoing transition 302 defined on Clip A starts at point 304 and ends at Clip A mark-out point 306. Incoming transition 308 defined on Clip B starts at Clip B mark-in point 310 and ends at point 312. In this scenario, the system implements a fade-through-black transition, starting at outgoing transition start point 304, fading to black at point 316 corresponding to mark-out point 306 and mark-in point 310 (i.e., the cut point), and then fading up to 100% opacity of Clip B at incoming transition end point 312. The fade-through-black transition follows from the general rule stated above, since the natural end state of each of the clips upon which a transition is defined is transparent black, and thus, when each clip is extended into its partner's transition with transparent black, the result is simply a fade to black of the content of each clip in its transition region. As with the previously described scenarios, the overall duration of the segment comprising Clips A and B remains the sum of the durations of the individual clips, i.e., it is unchanged by the implementation of this transition. As with the previous use scenario, if the user subsequently deletes one of Clips A or B, or replaces one of them with another clip, the transition regions 302 and 308 remain defined for Clips A and B respectively, and will be applied automatically to generate transitions in the new context.

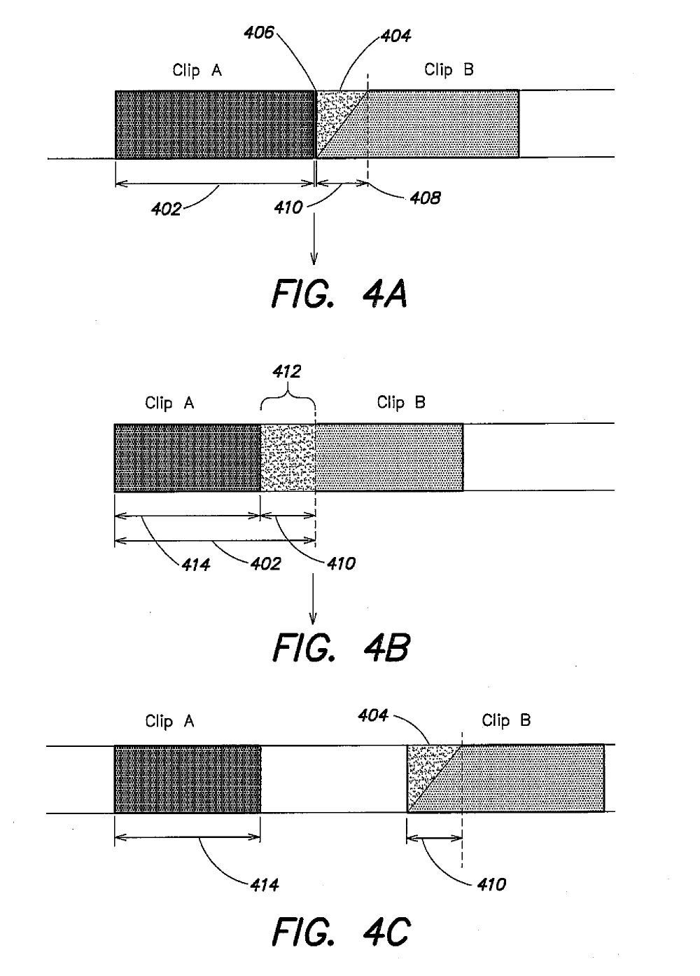

In a third scenario (FIG. 4), the user creates a transition by overlapping two adjacent clips, rather than by extending one or more clips into the transition region(s), as in the first two scenarios. In this case, the duration of the segment comprising the two clips is reduced by an amount corresponding to the time span of the overlap. As before, any transitions that are defined in this scenario remain defined on their respective clips until further user action explicitly changes the duration of the transition to zero, either by trimming the clip and/or the fade-in position, or by cutting away the portion of a clip containing the transition.

FIGS. 4A-4C illustrate how the user creates overlapping transitions. Clips A and B are adjacent to each other in the timeline, Clip A having duration 402. The user specifies that the transition to be defined is to be implemented as an overlapping transition and defines transition 404 on clip B spanning Clip B mark-in point 406 and transition end-point 408, having duration 410. As shown in FIG. 4B, the system implements transition 412 by overlapping Clip B and Clip A, shortening the duration of Clip A by an amount corresponding to duration 410 of the transition, with new Clip A length 414 equal to its original duration 402 minus transition duration 410. Note that, including transition 412, the effective duration of Clip B equals its original duration 402. In this scenario, no additional material is called upon to extend either clip into a transition, but instead an end portion of one of the clips (in this case Clip A) is used to partner with material of Clip B corresponding to the transition. If, as illustrated in FIG. 4C, Clips A and B are separated, transition 404 remains defined on Clip B. Clip A remains shortened to its residual length 414 after removal of the overlap portion that had been converted into part of transition 412.

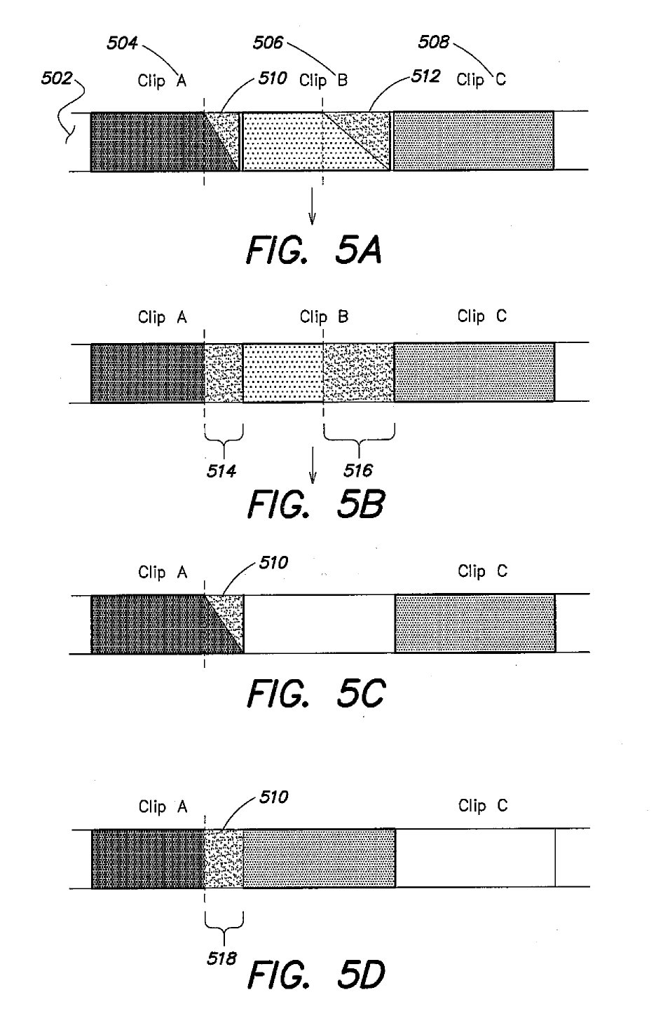

The advantages of transition object-free editing become even more apparent when more than two clips appear in sequence in the timeline. The behavior of the video editing system described above extends naturally to this situation. For example, in a fourth scenario, illustrated in FIG. 5A, timeline 502 includes three sequential clips, Clip A 504, Clip B 506, and Clip C 508. The user defines outgoing transition 510 on Clip A and outgoing transition 512 on Clip B. No transitions are defined on Clip C. As illustrated in FIG. 5B, the system implements transitions 514 and 516 using the method described above: Clip B is extended into Clip A to form transition 514, and Clip C is extended into Clip B to form transition 516. Assuming that the user has not requested that either transition be implemented as an overlapping transition, the duration of the segment comprising Clips A, B, and C including the transitions is the sum of the Clips' individual durations. If the user deletes Clip B (without opting to close the gap thus created), the result is as shown in FIG. 5C: Clip A retains its transition (510), and Clip C, as before, has no transitions defined on it. Each clip retains its original length, and the extension of Clip C generated to implement the transition with Clip B (FIG. 5B) is no longer present in the timeline. Next, if the user closes the gap between Clips A and C, the system implements new transition 518 by extending Clip C into Clip A transition region 510.

The methodology extends naturally to the situation in which the user replaces middle Clip B 506 with a fourth Clip D (not shown). In this case, the incoming and outgoing transitions (if any) defined on Clip D, together with outgoing transition 510 of Clip A serve to determine the new transition between Clips A and D and between Clips D and C.

Defining the transition as a property that is attached to the clip together with default rules as described above for generating a transition between two adjacent clips produces predictable and unambiguous results for the variety of scenarios that arise during video editing. In particular, synchronization between the content in different tracks is not lost as a result of manipulating the transitions, unless the user explicitly decides to create overlapping transitions in the video without applying a corresponding overlap in any other tracks for which synchronization is to be maintained.

In the foregoing, the rules for generating transitions focus particularly on the durations of incoming and outgoing transitions between one clip and another. Various rules determine what transition effect (i.e., combination rules for the original video inputs and other graphical elements) is to be applied to each transition during the course of adding, moving, and deleting clips within a timeline. In the described embodiment, the transition effect currently set as the default transition effect is applied. The preset default effect is a fade-in fade-out (dissolve) transition effect.

The user can change what the system should consider as the default effect, replacing it with one of a range of transitions available in the system library. Transition effects that have already been defined are not affected when the default is changed, as the default only defines which effect should be selected if none is specified explicitly. The user may manually change the type of effect applied at any transition at any time without affecting other already declared transitions. The user may create other rules to determine which effect is applied or alternatively request that the system prompt the user to make or affirm a selection of the effect to be applied. In other embodiments, the system supplies a rule based on user preferences and/or based on the nature of the video content of the clips or video presentation, or on other factors.

In order to provide the user of the video editing system with an intuitive graphical interface for implementing transitions, the described embodiment provides a means for identifying where clips and transition regions within the clips start and end, and for adjusting the duration of the clips and transition periods. In various embodiments, such means involves the use of graphical elements, such as markers, handles or tabs, to indicate clip mark-in points and mark-out points that correspond to the start and end of the clips respectively in the timeline. In some embodiments, the user interface displays an indication as to whether there is additional video content (i.e., additional “meat”) available beyond the mark-in or mark-out point. Such material may be used in implementing the extensions used in the transitions, as described above. In some embodiments, the interface further includes an indication of how much additional material is available in the clip beyond the mark-in/mark-out point. Each clip is provided with a graphical element for setting the duration of an incoming or outgoing transition. In the described embodiment, the user drags a first marker along the timeline to define the end point of an incoming transition, and a second marker to define the start of an outgoing transition. Referring again to FIG. 1, markers are used to show end 110 of incoming transition 106 or beginning 112 of outgoing transition 108.

In some embodiments, the video system interface provides a means for the user to specify that a transition is to be implemented by overlapping two clips. In an exemplary implementation, dragging a clip's transition marker outside its parent clip and into an adjacent clip in the timeline causes a transition to be defined on the parent clip as before, but implemented using material from within the overlapped portion of the adjacent clip, rather than from an extension of that clip beyond its mark-out point.

One advantage of transition object-free editing is that it eliminates situations that arise in prior video editing systems, that use transition objects, and in which video material is discarded when a clip is cut or when a transition object is removed. For example, a typical case arises when a timeline includes two clips separated by a transition object:

### AAAAAAxxxxxxBBBBBBBB

in which AAAAAA denotes a section of Clip A and BBBBBBBB a section of Clip B, joined by a transition object xxxxxx that was generated using material from each of clips A and B. If the user selects the transition xxxxxx and deletes it, the logical result is one of the three following cases.
a) AAAAAA BBBBBBB, where the transition is removed leaving a gap (black) between the two clips and the material corresponding to the transition region from both Clips A and B is lost.
b) AAAAAAaaabbbBBBBBBB, in which Clip A is extended by a section denoted as aaa and Clip B is extended by a section denoted as bbb, resulting in a hard cut, without a gap or transition between the clips. The position of the cut between material from Clip A and Clip B is not predefined and requires the use of a convention. Most of the conventions result in a loss of material from Clip A and/or Clip B. Some prior systems place the cut in the middle of the transition, in which case half of the transition material from each of Clips A and B is lost. Other prior systems fill the entire duration of the cut transition with the material from Clip A, discarding material corresponding to the transition period from Clip B.
c) AAAAAABBBBBB, in which the gap between the clips is closed up, and Clip B, as well as any other material to the right (i.e., later in time) of Clip B is rippled to the left by an amount corresponding to the duration of the transition. As for case a) above, all the material corresponding to the transition period from both Clips A and B is lost.

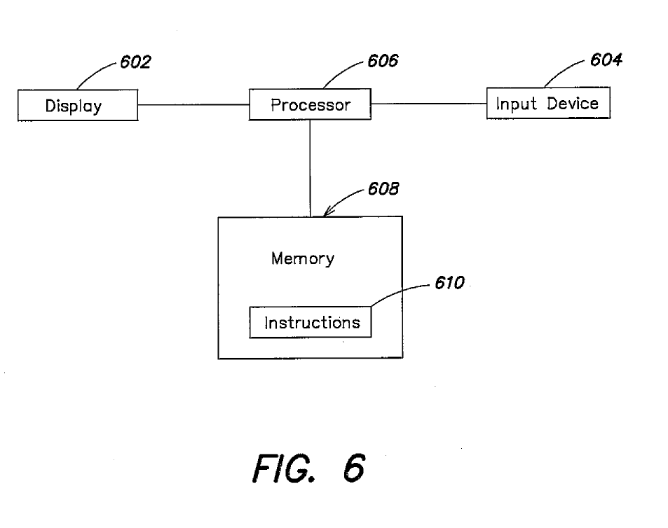

In addition to implementations of the described video editing system in various video processing products such as cameras, projectors, recorders, playback devices and the like, the various components of the system described herein may be implemented as a computer program using a general-purpose computer system. Referring to FIG. 6, such a computer system typically includes a main unit connected to both an output device, such as display 602, that displays information to a user and input device 604 that receives input from a user. The main unit generally includes processor 606 connected to memory system 608 via an interconnection mechanism. Instructions 610 for execution by the processor are stored in memory system 608. The input device and output device also are connected to the processor and memory system via the interconnection mechanism.

One or more output devices may be connected to the computer system. Example output devices include, but are not limited to, a cathode ray tube (CRT) display, liquid crystal displays (LCD) and other video output devices, printers, communication devices such as a modem, and storage devices such as disk or tape. One or more input devices may be connected to the computer system. Example input devices include, but are not limited to, a keyboard, keypad, track ball, mouse, pen and tablet, communication device, and data input devices. The invention is not limited to the particular input or output devices used in combination with the computer system or to those described herein.

The computer system may be a general purpose computer system which is programmable using a computer programming language, a scripting language or even assembly language. The computer system may also be specially programmed, special purpose hardware. In a general-purpose computer system, the processor is typically a commercially available processor. The general-purpose computer also typically has an operating system, which controls the execution of other computer programs and provides scheduling, debugging, input/output control, accounting, compilation, storage assignment, data management and memory management, and communication control and related services.

A memory system typically includes a computer readable medium. The medium may be volatile or nonvolatile, writeable or nonwriteable, and/or rewriteable or not rewriteable. A memory system stores data typically in binary form. Such data may define an application program to be executed by the microprocessor, or information stored on the disk to be processed by the application program. The invention is not limited to a particular memory system.

A system such as described herein may be implemented in software or hardware or firmware, or a combination of the three. The various elements of the system, either individually or in combination may be implemented as one or more computer program products in which computer program instructions are stored on a computer readable medium for execution by a computer. Various steps of a process may be performed by a computer executing such computer program instructions. The computer system may be a multiprocessor computer system or may include multiple computers connected over a computer network. The components described herein may be separate modules of a computer program, or may be separate computer programs, which may be operable on separate computers. The data produced by these components may be stored in a memory system or transmitted between computer systems.

Having now described an example embodiment, it should be apparent to those skilled in the art that the foregoing is merely illustrative and not limiting, having been presented by way of example only. Numerous modifications and other embodiments are within the scope of one of ordinary skill in the art and are contemplated as falling within the scope of the invention.

What is claimed is:

1. In a computer-based editing system for editing a video presentation, a method comprising:
placing a first video clip into a timeline, the timeline representing a time sequence of elements within the video presentation;
defining a transition region of the first video clip, the transition region of the first video clip having a start and an end, the transition region being one of an incoming transition region having a start corresponding to a first frame of the first video clip and an outgoing transition region having an end corresponding to a last frame of the first transition region, the transition region having a duration and specifying the region of the first video clip over which a transition effect is to be applied, wherein the transition region remains defined on the first video clip until the transition region is edited or deleted by a user of the computer-based editing system; and
generating a transition effect based at least in part on video content of the transition region of the first video clip.

2. The method of claim 1, wherein the transition region remains defined on the first video clip when the first video clip is moved from a first location in the timeline to a second location in the timeline.

3. The method of claim 2, wherein video content in the timeline adjacent to the transition region in the second location is different from video content in the timeline adjacent to the transition region in the first location.

4. The method of claim 1, wherein the transition region remains defined on the first video clip when video content in the timeline adjacent to the start of an incoming transition or the end of an outgoing transition region of the first clip is changed.

5. The method of claim 4, wherein changing the video content in the timeline adjacent to the transition region includes at least one of deleting a second video clip adjacent to the first video clip and inserting a second video clip adjacent to the first video clip.

6. The method of claim 1, wherein, if the transition region is an incoming transition region, the transition effect is a fade-in from transparent black at the start of the transition region to full opacity of the first video clip at the end of the transition region, and if the transition region is an outgoing transition region, the transition effect is a fade-out from full opacity of the first video clip at the start of the transition region to black at the end of the transition region.

7. The method of claim 1, further comprising:
placing a second video clip in the timeline, an adjacent end of the second video clip abutting the transition region defined on the first video clip; and
generating a transition effect between the first video clip and the second video clip by extending the second video clip to create an extension of the second video clip having a duration equal to the duration of the transition region of the first video clip, and combining video from the transition region of the first video clip with the extension of the second video clip.

8. The method of claim 7, wherein the second video clip is a portion of a source video clip, the source video clip having a duration longer than a duration of the second video clip in the timeline, and wherein the extension of the second video clip includes additional video from the source video clip extending beyond the adjacent end of the second video clip.

9. The method of claim 7, wherein the extension of the second video clip includes multiple repetitions of an end frame of the adjacent end of the second video clip.

10. A computer program product comprising:
a computer readable medium;
computer program instructions stored on the computer readable medium that, when executed by a computer, define an editing system for editing a video program and instruct the computer to perform a method for enabling a user to edit a video presentation, the method comprising:
placing a first video clip into a timeline, the timeline representing a time sequence of elements within the video presentation;
defining a transition region of the first video clip, the transition region of the first video clip having a start and an end, the transition region being one of an incoming transition region having a start corresponding to a first frame of the first video clip and an outgoing transition region having an end corresponding to a last frame of the first transition region, the transition region having a duration and specifying the region of the first video clip over which a transition effect is to be applied, wherein the transition region remains defined on the first video clip until the transition region is edited or deleted by a user of the computer-based editing system; and
generating a transition effect based at least in part on video content of the transition region of the first video clip.

11. The computer program product of claim 10, wherein the transition region remains defined on the first video clip when the first video clip is moved from a first location in the timeline to a second location in the timeline.

12. The computer program product of claim 10, wherein the transition region remains defined on the first video clip when video content in the timeline adjacent to the start of an incoming transition or the end of an outgoing transition region of the first clip is changed.

13. The computer program product 12, wherein changing the video content in the timeline adjacent to the transition region includes at least one of deleting a second video clip adjacent to the first video clip and inserting a second video clip adjacent to the first video clip.

14. The computer program product of claim 10, further comprising instructions stored on the computer readable medium that, when executed by a computer, instruct the computer to:
place a second video clip in the timeline, an adjacent end of the second video clip abutting the transition region defined on the first video clip; and
generate a transition effect between the first video clip and the second video clip by extending the second video clip to create an extension of the second video clip having a duration equal to the duration of the transition region of the first video clip, and combining video from the transition region of the first video clip with the extension of the second video clip.

15. The computer program product of claim 14, wherein the second video clip is a portion of a source video clip, the source video clip having a duration longer than a duration of the second video clip in the timeline, and wherein the extension of the second video clip includes additional video from the source video clip extending beyond the adjacent end of the second video clip.

16. The computer program product of claim 14, wherein the extension of the second video clip includes multiple repetitions of an end frame of the adjacent end of the second video clip.

17. A computer-implemented video editing system comprising:
a processor;
a display connected to the processor;
a memory connected to the processor, the memory including instructions that when executed on the processor, cause the processor to:
provide a graphical user interface on the display enabling the user to:
place a first video clip into a timeline, the timeline representing a time sequence of elements within the video presentation;
define a transition region of the first video clip, the transition region of the first video clip having a start and an end, the transition region being one of an incoming transition region having a start corresponding to a first frame of the first video clip and an outgoing transition region having an end corresponding to a last frame of the first transition region, the transition region having a duration and specifying the region of the first video clip over which a transition effect is to be applied, wherein the transition region remains defined on the first video clip until the transition region is edited or deleted by a user of the computer-based editing system; and
generate a transition effect based at least in part on video content of the transition region of the first video clip.

18. The computer-implemented video editing system of claim 17, wherein the transition region remains defined on the first video clip when the first video clip is moved from a first location in the timeline to a second location in the timeline.

19. The computer-implemented video editing system of claim 17, wherein the transition region remains defined on the first video clip when video content in the timeline adjacent to the start of an incoming transition or the end of an outgoing transition region of the first clip is changed.

20. The computer-implemented video editing system of claim 17, wherein changing the video content in the timeline adjacent to the transition region includes at least one of deleting a second video clip adjacent to the first video clip and inserting a second video clip adjacent to the first video clip.

21. The computer-implemented video editing system of claim 17, further comprising instructions that, when executed by a computer, cause the computer to:
place a second video clip in the timeline, an adjacent end of the second video clip abutting the transition region defined on the first video clip; and
generate a transition effect between the first video clip and the second video clip by extending the second video clip to create an extension of the second video clip having a duration equal to the duration of the transition region of the first video clip, and combining video from the transition region of the first video clip with the extension of the second video clip.

22. The computer-implemented video editing system of claim 21, wherein the second video clip is a portion of a source video clip, the source video clip having a duration longer than a duration of the second video clip in the timeline, and wherein the extension of the second video clip includes additional video from the source video clip extending beyond the adjacent end of the second video clip.

23. The computer-implemented video editing system of claim 17, wherein the extension of the second video clip includes multiple repetitions of an end frame of the adjacent end of the second video clip.
